(19) United States
(12) Patent Application Publication
(10) Pub. No.: US 2011/0089908 A1
(43) Pub. Date: Apr. 21, 2011

(54) CIRCUITRY FOR BALANCING CHARGING OF SERIES CONNECTED BATTERY CELLS

(75) Inventor: Tim A. Sunderlin, Henderson, NV (US)

(73) Assignee: K2 ENERGY SOLUTIONS, INC., Henderson, NV (US)

(21) Appl. No.: 12/871,471

(22) Filed: Aug. 30, 2010

Related U.S. Application Data
(60) Provisional application No. 61/253,651, filed on Oct. 21, 2009.

(51) Int. Cl. H02J 7/06; H02J 7/04

(52) U.S. Cl. 320/163

(57) ABSTRACT

For a circuit for preventing overcharging of a battery cell, the overcharging protecting circuit having a voltage detector for monitoring the voltage across the battery cell, a polarity protection circuit for protecting the voltage detector from a reverse polarity connection of the battery cell to the voltage detector is disclosed. The polarity protection circuit comprises a semiconductor device coupled across voltage detection inputs of the voltage detector. The semiconductor device is adapted to shunt current across the voltage detection inputs of the voltage detector when the battery cell is connected in reverse polarity to the voltage detector.

### CROSS-REFERENCE TO RELATED APPLICATION

This application claims the benefit of U.S. Provisional Application Ser. No. 61/253,651, filed on Oct. 21, 2009, the entirety of which is incorporated herein by reference.

### FIELD OF THE INVENTION

The present invention relates to battery charging circuitry to balance the charging of series connected battery cells, such as lithium ion battery cells.

The invention further prevents damage to battery cells if the cells are connected to the battery charging circuitry in reverse polarity.

### BACKGROUND OF THE INVENTION

The nominal voltage of a fully charged lithium iron phosphate (LFP) battery cell is approximately 3.65 volts. This voltage is battery chemistry dependent and can vary for battery cells having other lithium ion chemistries.

When charging series connected lithium ion battery cells, the cells do not necessarily charge at the same rate. Thus one of the battery cells may begin to exceed its nominal voltage before the other battery cell, or cells, reach their nominal voltage(s). As battery chargers typically do not stop charging the series connected cells until the cumulative series voltage of the cells reaches a threshold voltage, the cell which first reaches its nominal voltage may end up being over-charged, which can damage the particular battery cell.

There can also be a problem if the battery charger is connected to one or more battery cells in reverse polarity.

The present invention is provided to address these and other problems.

### BRIEF DESCRIPTION OF THE DRAWINGS

FIG. 1 is a block diagram of a battery charger coupled to two series connected battery cells, in accordance with the present invention;

FIG. 2 is a schematic of a first embodiment of a circuit contained in the battery charger of FIG. 1, the circuit for balancing the charging of the battery cells; and

FIG. 3 is a schematic of a second embodiment of a circuit contained in the battery charger of FIG. 1, the circuit for balancing the charging of the battery cells.

### DETAILED DESCRIPTION

While this invention is susceptible of embodiments in many different forms, there is shown in the drawings and will herein be described in detail, preferred embodiments of the invention with the understanding that the present disclosure is to be considered as an exemplification of the principles of the invention and is not intended to limit the broad aspects of the invention to the embodiments illustrated.

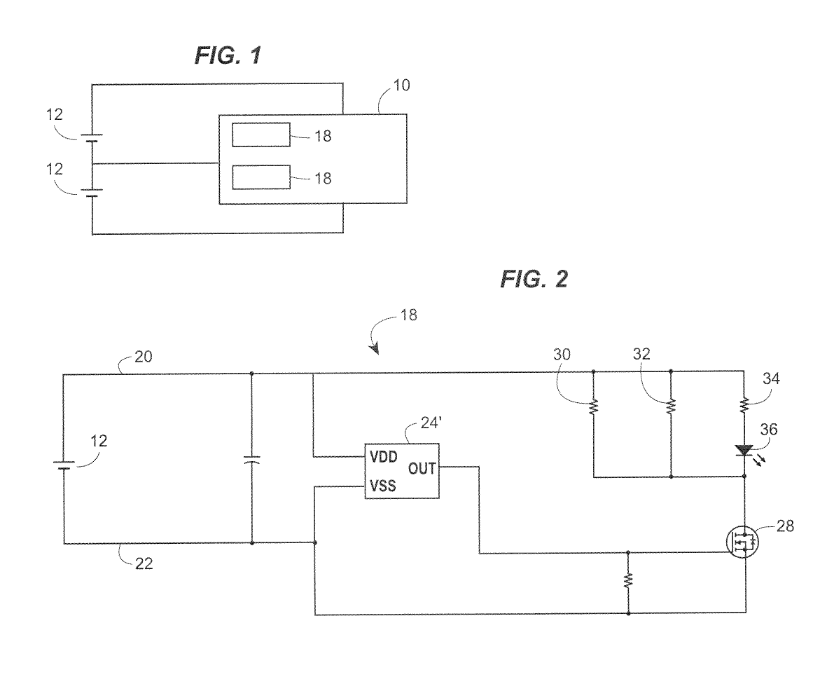

A battery charger 10 coupled to two battery cells 12, is illustrated in FIG. 1. The battery cells 12 may be conventional lithium iron phosphate battery cells, of the type having a nominal fully charged voltage of 3.65 volts, or may be another type of rechargeable battery cell.

Associated with the battery charger 10 are a plurality of battery charging circuits 18, one associated with each of the battery cells 12.

A schematic of a first embodiment of the battery charging circuit 18 is illustrated in FIG. 2. The battery charging circuit 18 includes a first electrode 20 coupled to a positive terminal its respective battery cell 12 and a second electrode 22 coupled to a negative terminal of its respective battery cell 12.

The battery charging circuit 18 includes a voltage detector 24, such as an S-80835 IC voltage detector having a 3.5 volt detection voltage value, sold by Seiko Instruments, Inc., Japan. The battery charging circuit 18 further includes an electronic switch 28, such as a Zetex N-channel MOSFET, model ZXMN6A07FTA, sold by Diodes Incorporated of Dallas, Tex. The battery charging circuit 18 also includes a conventional yellow LED 36.

In normal operation, the battery charger 18 provides current through the serially connected cells 12. The voltage detector 24 associated with each of the cells 12 monitors the voltage across its respective one of the cells 12. As long as the voltage is sufficiently low, the output of the voltage detector 24 maintains the electronic switch 28 in an open position. Thus the charging current will flow through the respective cell 12. However when the voltage detector 24 detects the voltage across its respective cell 12 has reached a voltage in the range of 3.6 to 3.68 volts, the output of the voltage detector 24 causes the electronic switch 28 to close, thus shunting charging current around that particular cell 12, through resistors 30, 32 and 34, and effectively stopping the charging of that particular cell 12. Also this shunted current also illuminates the LED 36. Multiple resistors are utilized in parallel to reduce the current through any particular one of the resistors, thus permitting lower wattage resistors to be utilized.

Should the voltage across that particular cell 12 subsequently drop below 3.5 volts, the voltage detector will cause the electronic switch 28 to again open, causing the full amount of charging current to flow through the particular cell 12.

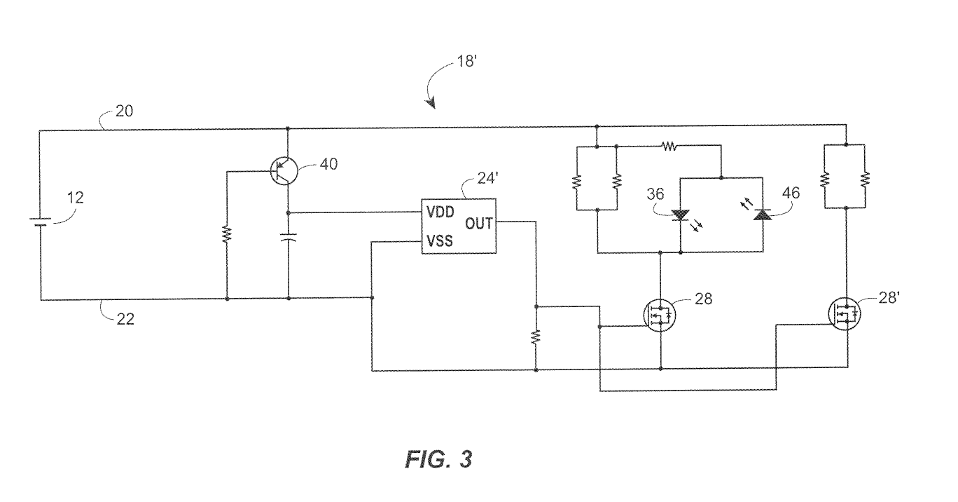

A second embodiment of the present invention is illustrated in FIG. 3. The second embodiment protects the battery cell should the battery cell be connected to the the charger in reverse polarity. If in reverse polarity, typical battery chargers are fine, as typically they are current limited to allow only a limited amount of current to charge the battery cells. Further the battery cells would typically not be damaged until the conventional charger depletes the stored charge of the battery cells being charged. At that point, the conventional battery cell charger would typically attempt to charge the battery cells in the reverse direction. An Ideal capacitor, rather than a battery cell, would charge to negative polarity. However battery cells would tend to develop internal shorts due to the chemistry involved.

In the embodiment illustrated in FIG. 2, the voltage detector used determines when to do the balance current bleed, or overflow, and this item could be damaged due to a reversed input polarity.

A second embodiment of the battery charging circuit 18′ is illustrated in FIG. 3. This circuit 18′ is provided to protect the voltage detector 24 should the battery cell 12 be connected in reverse polarity.

The circuit 18′ includes a diode-like device in the form of a PNP transistor 40 in the circuit path to shunt, and thereby eliminate, any current from reverse polarity connections for the voltage detector 24.

The battery charging circuit 18′ according to the second embodiment includes a voltage detector 24′ having a lower detection voltage value than the voltage detector 24 discussed above, to compensate for the approximately 0.2v voltage drop across the transistor 40. The voltage detector 24′ may be an NCP300LSNT1G voltage detector, sold by ON Semiconductor, Phoenix, Ariz., or an S-80834CLMC-B6TT2G voltage detector, sold by Seiko Instruments, Japan.

The second embodiment 18′ further includes a second electronic switch 28′ and a second pair of parallel resistors, in parallel with the first electronic switch and corresponding parallel pair of resistors, to reduce the amount of shunted current through the first electronic switch 28. The first and second electronic switches 28, 28′ include an inherent diode characteristic which permits current flow should the battery cell 12 be installed in a reverse-biased manner. This current flow illuminates a Red LED 46 to indicate when current is flowing in the wrong direction. The electronic switches 18, 18′ and the LED's 36, 46 are not adversely affected by a reverse battery cell connection.

It should be noted that even with the circuit 18′, it is possible to connect the charger to the battery cell 12 in reverse polarity and deplete the charge of the battery cell. The polarity protection is for the balancing circuit when connecting to the battery cells.

While specific embodiments have been illustrated and described, numerous modifications may come to mind without significantly departing from the spirit of the invention, and the scope of protection is only limited by the scope of the accompanying claim.

1. For a circuit for preventing overcharging of a battery cell, the overcharging protecting circuit having a voltage detector for monitoring the voltage across the battery cell, a polarity protection circuit for protecting the voltage detector from a reverse polarity connection of the battery cell to the voltage detector, the polarity protection circuit comprising a semiconductor device coupled across voltage detection inputs of the voltage detector, the semiconductor device adapted to shunt current across the voltage detection inputs of the voltage detector when the battery cell is connected in reverse polarity to the voltage detector.

2. The polarity protection circuit of claim 1, wherein the semiconductor device comprises a transistor.

3. The polarity protection circuit of claim 2, wherein the transistor comprises a bipolar transistor.

4. The polarity protection circuit of claim 3, wherein the bipolar transistor comprises a PNP transistor.

5. The polarity protection circuit of claim 1 including an indicator for indicating a reverse polarity connection of the battery cell to the voltage detector.

6. The polarity protection circuit of claim 6 wherein the indicator comprises an LED coupled in series with the semiconductor device.

7. A circuit for preventing overcharging a battery cell comprising:
a voltage detector for monitoring a voltage across a battery cell, the voltage detector configured to determine when the voltage across the battery cell is greater than a first threshold voltage;
an electronic switch responsive to the voltage detector and configured to shunt current around the battery cell when the voltage detector has determined the battery cell voltage is greater than the first threshold voltage; and
a semiconductor device coupled across voltage detection inputs of the voltage detector, the semiconductor device adapted to shunt current across the voltage detection inputs of the voltage detector when the battery cell is connected in reverse polarity to the voltage detector.

8. The polarity protection circuit of claim 7, wherein the semiconductor device comprises a transistor.

9. The polarity protection circuit of claim 8, wherein the transistor comprises a bipolar transistor.

10. The polarity protection circuit of claim 9, wherein the bipolar transistor comprises a PNP transistor.

11. The polarity protection circuit of claim 7 including an indicator for indicating a reverse polarity connection of the battery cell to the voltage detector.

12. The polarity protection circuit of claim 11 wherein the indicator comprises an LED coupled in series with the semiconductor device.

13. The circuit of claim 7 wherein:
the voltage detector is configured to determine when the voltage across the battery cell is less than a second threshold voltage; and
the electronic switch is configured to cease shunting current around the battery cell when the voltage detector has determined the voltage across the battery cell is less than the second threshold voltage.

14. The circuit of claim 13 wherein the second threshold voltage is less than the first threshold voltage.

15. The circuit of claim 14 wherein the electronic switch comprises a semiconductor device.

16. The circuit of claim 15 wherein the electronic switch comprises a plurality of semiconductor devices coupled in parallel.

17. The circuit of claim 7 wherein the electronic switch comprises a MOSFET semiconductor device.

18. The circuit of claim 7 wherein the electronic switch comprises a plurality of MOSFET semiconductor devices coupled in parallel.

19. The circuit of claim 7 including an indicator for indicating that current is being shunted around the battery cell.

20. The circuit of claim 7 including an indicator for visually indicating that current is being shunted around the battery cell.

21. The circuit of claim 9 wherein the visual indicator comprises an LED coupled in series with the electronic switch.
